(19) United States
(12) Patent Application Publication
(10) Pub. No.: US 2021/0379757 A1
(43) Pub. Date: Dec. 9, 2021

(54) ROBOTIC MANIPULATION OF PV MODULES

(71) Applicants: Travis Schneider, Pittsburgh, PA (US); Arthur Reeg Allen, III, Pittsburgh, PA (US); Amanda Sgroi, Pittsburgh, PA (US)

(72) Inventors: Travis Schneider, Pittsburgh, PA (US); Arthur Reeg Allen, III, Pittsburgh, PA (US); Amanda Sgroi, Pittsburgh, PA (US)

(21) Appl. No.: 17/341,541

(22) Filed: Jun. 8, 2021

Related U.S. Application Data
(60) Provisional application No. 63/035,949, filed on Jun. 8, 2020.

(51) Int. Cl. B25J 9/16; H02S 20/10; B66F 11/04; B25J 5/00; B25J 5/04; G05D 1/02; B25J 19/00; B25J 13/08

(52) U.S. Cl. CPC B25J 9/162; H02S 20/10; B66F 11/044; B25J 5/00; B25J 5/04; B25J 9/1697; B25J 15/00; B25J 19/0025; B25J 13/08; G05D 1/0251; G05D 1/0253; G05D 2201/0202; G05D 1/0278

(57) ABSTRACT

A robotic PV module installation system for populating a solar generation plant with PV modules with minimal human intervention. The PV module installation system can include an aerial work platform (AWP), a linear slide, and a robotic arm. The AWP can include an articulated boom. The AWP can also be configured for movement over off-road terrain. The linear slide can be coupled to a free-end of the articulated boom. The robotic arm can be coupled to a slide of the linear slide to increase a horizontal reach of the robotic arm through movement of the slide along the linear slide. The robotic arm can also include an end of arm tooling configured to pick up PV modules.

### PRIORITY APPLICATIONS

This application claims the benefit of priority to U.S. Provisional Patent Application Ser. No. 63/035,949, filed Jun. 8, 2020, the content of which is incorporated herein by reference in its entirety.

### TECHNICAL FIELD

This document pertains generally, but not by way of limitation, to robotically assisted assembly of photovoltaic (PV) modules for solar power generation plant. More particularly, this disclosure relates to, but not by way of limitation, a mobile robotic manipulator for PV modules and an associated robotic delivery vehicle.

### BACKGROUND

Photovoltaic power plants can involve a large number of PV panels spread out over a wide area. Each of the PV panels or modules can weigh in excess of 25 kg and are typically manually installed onto a racking system from pallets. Approximately 50% of the soft costs associated with constructing a PV plant can be attributed to delivery and installation of PV panels.

Cost reduction efforts continue to lower the cost of utility scale solar. Overall, this is due to major hardware cost reduction efforts, however in recent history soft costs associated with solar construction have either plateaued if not risen. Soft costs are a general category of the non-hardware related costs required to produce a solar field. Of the soft costs identified in the National Renewable Energy Laboratory (NREL) 2018 benchmark study, approximately $0.10-$0.13/Watt stems from installation labor and equipment for utility-scale PV installations. This is the single largest contributor of the soft costs category, or 25% of the $0.39/Watt baseline established by the Solar Energy Technology Office (SETO). Based upon its independent research collected from a variety of Solar Engineering, Procurement, and Construction (EPC) companies, the inventors have determined that approximately 50% of all labor hours required to produce a new solar plant is attributed to the delivery of panels to their installation location, as well as the physical installation of solar modules.

Accordingly, there is a need to optimize the flow of panels from drop off to installation in order to minimize this portion of the soft costs associated with PV plant construction.

### OVERVIEW

In order to address the issues with manual installation of PV panels during construction and maintenance of a PV plant, the current inventor has developed a robotic system to support the PV plant construction process. The current concept utilizes a fleet of coordinated delivery and installation vehicles. The fleet of vehicles includes delivery vehicles for shuttling PV panels to the physical installation location, which can be a significant distance from any panel delivery point. The fleet of vehicle also includes a robotic installation vehicle that physically manipulates the PV modules into place on the racking systems.

One additional feature of the current concept is the in-field transfer of electrical power from the delivery vehicles to the robotic installation vehicle. In examples where the robotic installation vehicle is fully electric, the delivery vehicles can be configured to provide battery charging upon docking with the robotic installation vehicle. While the PV panels are installed from the delivery vehicle, the delivery vehicle can be electrically coupled to the robotic installation vehicle and deliver battery charging to the robotic installation vehicle.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a perspective view of a PV panel installation system operating within a solar power generation plant, according to various example embodiments.

FIG. 2 is a block diagram illustrating system components for a PV installation system, according to various example embodiments.

FIGS. 3A-3C are perspective views illustrating a robotic PV panel installation system setting up a solar power generation plant, according to various example embodiments.

FIG. 4 is a flowchart illustrating a technique of populating a solar generation plant with PV modules, according to various embodiments.

FIG. 5 is a block diagram illustrating an example computing device capable of performing aspects of the various techniques discussed herein.

The headings provided herein are merely for convenience and do not necessarily affect the scope or meaning of the terms used.

### DETAILED DESCRIPTION

The present application relates to vehicles, systems and mechanisms for delivering and installing PV modules during construction of a PV power plant. More specifically, the present application discusses an autonomous working vehicle with a robotic arm for installing PV modules and an autonomous delivery vehicle for delivering PV modules to an installation location. Additionally, a robotic PV installation system is discussed that is built around a MG® Boom Lifts or more generically an Aerial Work Platform (AWP). The AWP based system includes a robotic arm mounted on a linear slide that is in turn mounted on the boom of the AWP.

### Definition of Terms

Manipulator a robotic arm or device used to move objects in space.

PV module an individual solar panel to be installed.

PV module racking system—the mechanical elements that secure PV modules within a PV power plant, racking system can include fixed tilt, single axis, or dual axis tracking systems.

EOAT—end of arm tooling, often customized element at the end of a robotic arm used to interface with specific objects.

UGV—unmanned ground vehicle, often used to provide mobility (other similar vehicles: AGV—autonomous guided vehicle, AMR—autonomous mobile robot). These are often either powered by an onboard battery hank, or a diesel- or gas-powered generator.

Perception system—a series of various sensors connected to computing device in order to perceive and locate objects

AWV—autonomous working vehicle, responsible for manipulating PV modules

ADV—autonomous delivery vehicle, responsible for delivery of PV modules to an installation site.

AWP—aerial work platform, which can be a commercially available aerial work platform from manufactures such as JLG Industries, Inc. of Oshkosh, Wis. In some examples, a JLG® 450AJ Boom Lift with Articulating Boom can be used as the AWP, see https://www.jlg.com/en/equipment/engine-powered-boom-lifts/articulating/450-series/450aj (last visited May 26, 2021). Vehicles with similar capabilities are also referred to as Mobile Elevating Work Platforms (MEWP).

O-AMPP—The inventors' solution to the problems discussed herein, titled “Outdoor Autonomous Manipulation of Photovoltaic Panels (O-AMPP)”, fuses computer vision and machine learning algorithms, a customized sensor solution, customized End-Of-Arm Tooling (EOAT), industry-leading power-dense, outdoor-rated robotic arm technology, and best-in-class outdoor unmanned ground vehicles (UGVs), to produce an innovative solution that will reduce the cost and time for producing a new solar plant.

### Concept Overview

In concept, modules are unloaded from tractor-trailers onto an autonomous delivery vehicle (ADV). These delivery vehicles then navigate the solar plant and present solar modules to an autonomous working vehicle (AWV), which picks and places panels from the delivery vehicle onto the solar racking system. In order to eliminate wasted motion, the AWV addresses either side of two parallel solar racking systems. Once a module is secured to either rack, both the AWV and ADV index to the next installation location. Once the ADV is exhausted of panels it returns to the loading point and a second ADV takes its place. This process would be repeated until the PV plant is populated with panels.

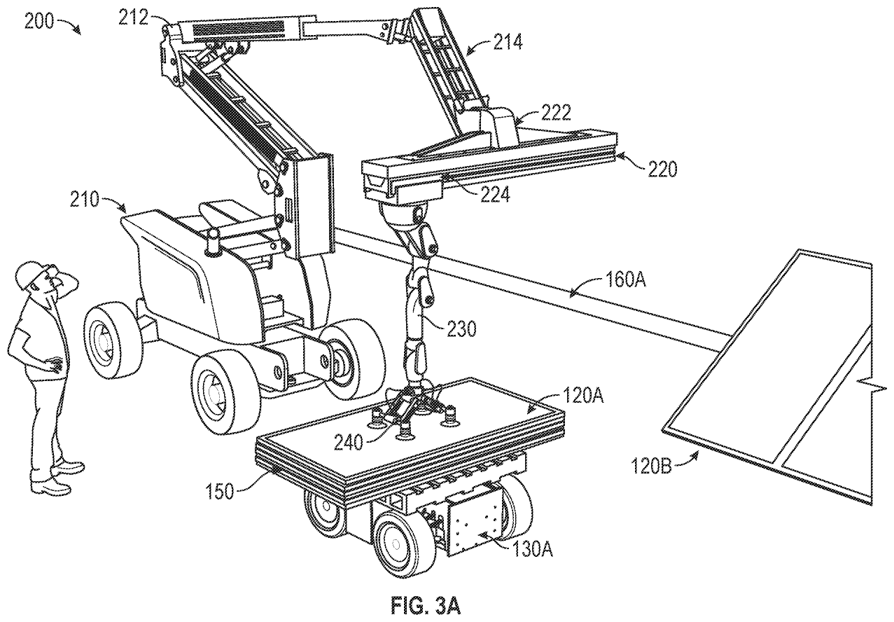

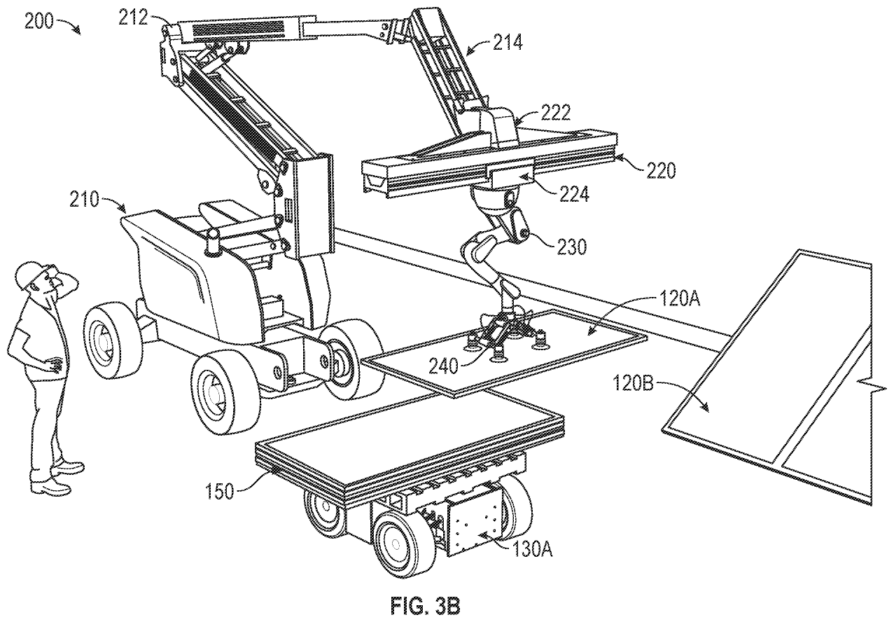

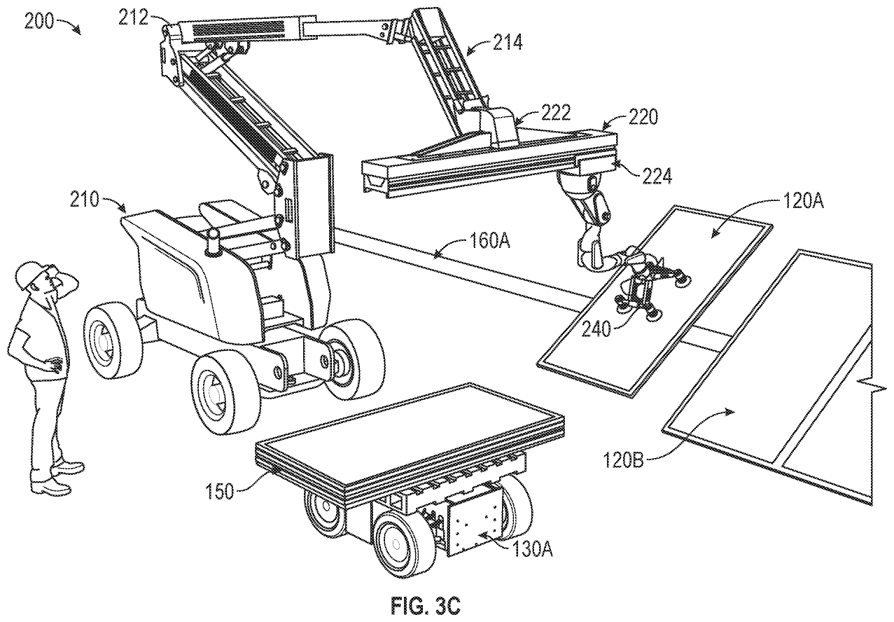

As introduced above, one of the PV installation systems discussed above uses an AWP as the base vehicle for a robotic manipulator that positions the PV modules. Referred to as the O-AMPP concept, the system can include components such as the following (reference numbers relate to FIG. 3A):

A JLG® AWP 210.

An integrated linear slide 220.

A Sapien manipulator from RE² Robotics of Pittsburgh, Pa. (robotic arm 230), for additional details see https://www.resquared.com/re2sapien (last visited May 25, 2021).

Custom End of Arm Tooling (EOAT), EOAT 240.

Custom perception sensor(s).

Once integrated these components function as system according to the following method for manipulation and installation of PV panels. In this example method there are two types of motions, coarse boom arm motion provided by the AWP 210, and fine manipulator arm motion provided by the linear slide and RE2 Sapien manipulator (robotic arm 230). To pick up PV modules first perception sensors and computer vision is used to detect and locate key objects of interest including the modules and the racking system 160A. Once these items are detected and located, first coarse boom arm motion is performed to align the linear slide 220 and robotic arm 230 in the PV module stack area (e.g., over ADV 130A and PV modules 150). When that motion is complete, fine manipulator arm motion is used to operate the robotic arm 230 to grasp PV modules, such as PV module 120A, with the EOAT 240. The process continues in reference to FIGS. 3B and 3C, with the robotic arm 230 positioning and installing the PV module 120A onto racking system 160A. Once a module, such as PV module 120A, is being held securely by the EOAT 240, coarse boom arm motion is used to place the robotic arm 230, linear slide 220, EOAT 240, and PV module 120A in the placement position (FIG. 3C). Depending upon the exact position of components (height variation of the racking system, etc. . . . ) additional coarse motion may not be required.

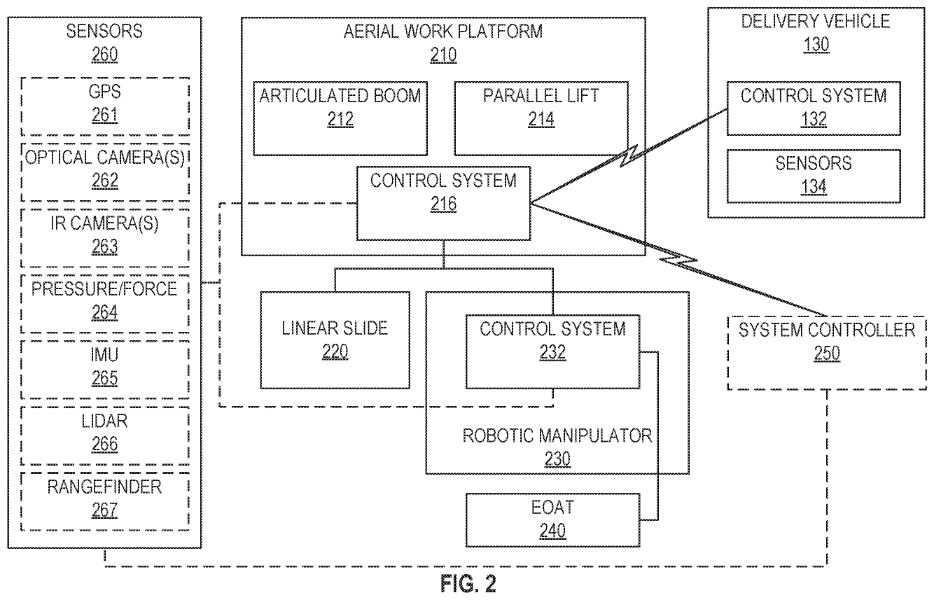

Again, when that motion is complete, fine manipulator motion is used to operate the Sapien manipulator (robotic arm 230) and linear slide 220 to place the PV module 120A over the module racking system 160A based upon perception data, such as from sensors 260 (see system block diagram in FIG. 2). Once precisely positioned above the racking system, the O-AMPP system will hold the module in a pose, such that racking system clamps can be secured. In some examples, securing the PV module 120A is performed manually by an operator. In other examples, the ADV 130 or separate autonomous vehicle includes a separate robotic arm fitted with appropriate end effector for securing the PV modules to the racking system. In certain examples, the EOAT can be configured to perform both positioning of the PV module and securing the PV module to the racking system. Securing the PV module can include operating a tool to torque clamps into a secure position.

Once secured to the racking system the ground vehicle, such as AWP 210, will index forward to the next location moving in parallel to the racking system approximately one modules width (1 meter). This process is then repeated once the ground vehicle is moved to the next location. In an example, movements of the AWP 210, the linear slide 220 and the robotic arm 230 do not need to be coordinated by a single controller. Thus, eliminating the need for coordinated control between the JLG® boom arm (such as articulated boom 212 and parallel lift 214) and the robotic arm 230 since each component moves independently and only after the other is secured in a safe location or position. Even in this example, collision avoidance between the robotic arm 230 and the articulated boom 212 will still need to be implemented. In another example, a single controller, such as system controller 250, can be used to coordinate movements of the entire PV panel installation system 200. In a unified control scenario, a Unified Robot Description Format (URDF) can be utilized to communicate across the different platforms.

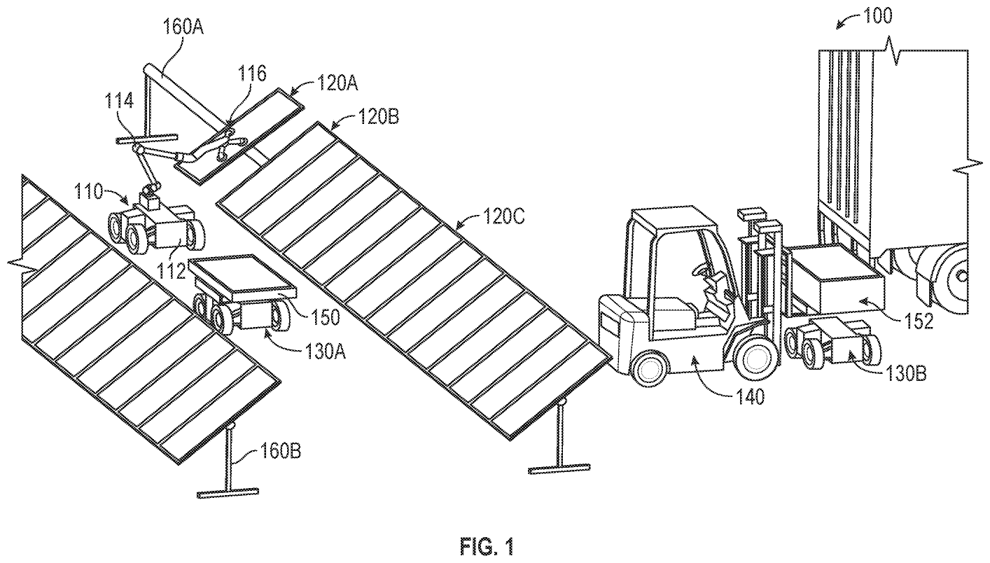

FIG. 1 is a perspective view of a PV panel installation system 100 operating within a solar power generation plant. In this example, the PV panel installation system 100 is a fully autonomous robotic system, including two types of vehicles, (1) a working vehicle, such as the AWV 110, which picks and places panels onto the solar racking system from the delivery vehicle, such as ADV 130A, 130B (commonly discussed as ADV 130). A series of delivery vehicles are used to move PV modules from a loading point to the working vehicle, which is located at the point of installation. In this example, ADV 130A is illustrated delivering PV modules 150 to the AWV 110, while ADV 130B is illustrated receiving PV modules 152 from a delivery truck. The system 100 can include an AWV 110, a first ADV 130A, and a second ADV 130B, the AWV 110 can include a robotic arm 114 and an end effector 116. FIG. 1 illustrates the AWV 110 placing PV module 120A using the robotic arm 114 and end effector 116. In this example, the end effector 116 includes a plurality of vacuum cups for securing the PV module 120A, other coupling device could also be implemented. The system 100 is used, in this example, to populate a solar power generation farm including two sets of module racking, racking system 160A and racking system 160B. As illustrated, each module rack can hold multiple PV modules (e.g., PV module 12013 and PV module 1200, which are intended to be representative of the array of PV modules installed). In some examples, each module rack, such as racking system 160A, can include multiple rows of PV modules.

A key to efficient installation of the PV modules is the capability of these various vehicles to work as a coordinated fleet, such that PV modules (150, 152) are continually fed to the AWV 110 by a number of ADVs, such as ADV 130A and ADV 130a In order to optimize not only the flow of material but also the speed with which a new PV plant is constructed a network of multiple AWVs, and ADVs can also be deployed. In an example using a network of multiple AMVs and ADVs, a central control system, such as system controller 250, is employed to coordinate operations of the various vehicles. Additionally, the AWV 110 can be configured to populate multiple rows of adjacent PV modules, such as on racking systems along either side of the vehicle or racking systems with multiple rows of modules.

In an example, the AWV 110 includes of an EOAT 116, which grasps PV modules in order to manipulate them from the ADV 130A to the PV module racking system 160A, 160B. Connected to the EOAT 116 is a manipulator or robotic arm 114 which is used to manipulate the PV modules 120A, 150. The manipulator is integrated to a UGV 112 providing mobility for the entire AWV 110. Also integrated to the UGV 112 is a series of perception sensors, which are able to detect and locate PV modules 120A, 150, as well as key module racking components in order to properly mount. PV modules, such as PV module 120A, to the racking system 160A. This perception system may also be used as a safety device in order to detect humans coming in close proximity to the AWV 110. The perception system can include sensors such as, optical cameras (monocular and stereo), infrared (IR) sensors, pressure sensors, inertial measurement units (IMUS), LIDAR cameras, and rangefinder sensors (sonar, laser, structured light), among others. In addition, to this module perception system the AWV 110 uses a navigation system, such as a Global Positioning Sensor (GPS), which will allow it to navigate within the PV field. The AWV 110 may also have a secondary manipulator which makes use of another EOAT that is used to secure PV module clamps. This EOAT may include an electrically driven device that interfaces with the clamps in order to properly secure modules to the module racking system.

Working in coordination with the AWV 110 is the ADV 130. As noted earlier the ADVs will deliver PV modules from their drop off point, and navigate their way through a PV field in order to locate the AWV 110 and provide it with panels to be secured to the module racking system. The ADV will consist of a. UGV to provide it with the appropriate mobility, to carry and move the PV modules throughout the solar field. The UGV will be outfitted with a platform on which new modules will be loaded onto. In addition, the ADV 130 will also be outfitted with a navigation system allowing it to navigate from the module drop off point to the installation location. Like the AWV 110, the ADV 130 will also make use of a perception system which is used to detect human workers, or obstacles which may interfere with its path. In operation, the ADV 130 will be loaded with PV modules, usually palletized, by a forklift, such as forklift 140.

Another aspect to enhance the performance of this fleet of robotic systems (AWV, and ADV) is maintaining a constant flow of modules from drop off location to the installation site, and maintain high uptime for the AWV. In order to maintain this uptime, the AWV utilizes an integrated diesel, or gasoline powered generator to provide the necessary energy capacity. In another example, both the AWV and ADV are electric vehicles, with the ADVs including a high-power electrical charge transfer system to recharge the AWVs in the field. In this example, while ADVs are being loaded with PV modules they can be plugged into a static charge point to keep their charge topped off as much as possible. When commanded to, the ADV will then disconnect itself from the charge point, and navigate to meet the AWV. The ADV would then dock to the AWV in order to pass its excess electrical charge from its batteries onto the AWV, which will be under higher demand with more limited availability of alternative charge sources. Once an ADV has been exhausted of its PV modules it would then return to its dock in order to charge its batteries again and reload with PV modules.

In another example, each of the many ADVs docks with the AWV during PV module installation, and while docked the AWV operates from batteries on-board the ADV. In this example, the AWV includes secondary on-board batteries that power the vehicle between ADV docking sessions. In this example, the energy intensive operations of the AWV are reserved for time periods when an ADV is docked to provide the necessary power. The AWV can also include an auxiliary gas or diesel engine or generator to provide back-up power for extended operation time or for use in major movements of the vehicle.

FIG. 2 is a block diagram illustrating system components for a PV installation system, such as system 200 discussed herein. In this example, the PV installation system can include components such as an ADV 130, an AWP 210, a linear slide 220, a robotic manipulator (arm) 230, an EOAT 240, and optionally a system controller 250. The system 200 can also access a variety of sensors, such as sensors 260. In an example, sensors 260 can optionally include sensors such as a global positioning sensor (GPS) 261, an optical camera 262, an infra-red (IIS) camera 263, a pressure or force sensor 264, an inertia measurement unit (IMU) 265, a lidar sensor 266, and/or a rangefinder sensor 267. In some examples, each of the AWP 210, the robotic manipulator 230, the system controller 250, and the ADV 130 can include some or all of sensors 260. In certain examples, some or all of the sensors 260 are embedded into each of the AWP 210, the robotic manipulator 230, and the ADV 130 with the system controller 250 able to communicate with each vehicle and receive some or all of the data from sensors 260.

In this example, the AWP 210 can include an articulated boom 212, a parallel lift mechanism 214 and a control system 216. The control system 216 communicates with and controls the articulated boom 212 and the parallel lift mechanism 214 to position the linear slide 220 and robotic manipulator 230. In certain examples, the control system 216 within the AWP 210 uses sensors 260 to perceive the operating environment and locate critical landmarks, such as a racking system or other features of the solar generation plant. The control system 216 can operate the AWP 210 autonomously or receive inputs from a manual control interface to allow an operate to manually manipulate the AWP 210.

In this example, the robotic manipulator 230 can include a control system 232 that can also be in communication with the linear slide 220 and the EOAT 240 to coordinate and control movement of these devices as a unit. The control system 232 can also access or include at least some of sensors 260 to evaluate the environment and manipulate the PV modules. In an example, the control system 232 accesses sensors 260, such as optical cameras 262 and IR cameras 263 to locate PV modules delivered by the ADV 130. The control system 232 can received a two dimensional (2D) image from an optical camera 262 for processing to roughly locate a PV module using common machine vision techniques such as edge detection or blob analysis. The controls system 232 can also (or alternatively) receive three dimensional (3D) data from a stereo pair of optical cameras, such as optical cameras 262, or IR cameras, such as IR cameras 263. The 3D data can be analyzed to map precise location and orientation of the PV modules, as well as portions of the racking system, such as the mounting location. The control system 232 can operate as a perception system for the robotic manipulator 230 to assist in picking up and placing a PV module on a racking system as discussed herein. The perception system (e.g., control system 232 in this example) can access other sensors, such as a force sensor 264, a lidar sensor 266 and/or a rangefinder sensor 267 to provide additional 2D and 3D information about the surroundings and operation of the linear slide 220, EMT 240, and the robotic manipulator 230.

The linear slide 220, in this example, includes a servo motor and related control circuits that can communicate with the control system 232 and/or control system 216. In certain examples, the linear slide 220 can be controlled by the system controller 250. In yet other examples, the linear slide 220 can be controlled indirectly by the system controller 250 through either of the control systems 216 or 232. The linear slide 220 operates to provide extended horizontal reach for the robotic manipulator 230.

In an example, the ADV 130 can include a control system 132 and sensor package 134. Like sensors 260, the sensor package 134 can include a variety of perception sensors to assist the ADV 130 in navigating the solar generation plant to delivery PV modules to the AWP 210. For example, the sensor package 134 can include a GPS 261 and optical cameras 262 to provide navigation input. In another example, the sensor package 134 may also include a lidar sensor 266 and an IMU 265. In certain examples, the ADV 130 can utilize a CPS to navigate to pre-programmed waypoints. In these examples, the GPS can be augmented with optical cameras or other distance sensors to avoid any unexpected obstacles and enhance the accuracy of the GPS alone. The primary role of the ADV 130 is to delivery PV modules from a delivery point to the AWP 210 working within the racking systems of the solar generation plant. The ADV 130 can be configured to carry one or multiple pallets of PV modules. The pallets of PV modules can be stacked or positioned next to each other on the ADV 130.

Within system 200, the sensors 260 operate as perception sensors to assist one of the various vehicles and the robotic manipulator in delivering and installing the PV modules on racking systems. The system 200, for example one of the control systems 216 and 232, will receive and process a combination of 2D and 31) sensor data to map the environment. For 2D sensing high resolution color imagery can be captured with an optical camera, such as optical camera 262. The 2D data can then be correlated with concurrently captured 3D depth and point cloud data, captured from sensors such as multiple IR cameras 263, a lidar sensor 266 and/or rangefinder sensors 267 (such as time-of-flight sensors). The 3D data can also include optical camera data captured by a pair of stereoscopic optical cameras, which allows for a processors to triangulate objects within the scene. As an example, detection of PV modules can involve processing 2D image data for a large, mostly black, reflective rectangle using a blob analysis algorithm, and then employ an edge detection mechanism to project the sides and corners of the PV module. The 2D edge and corner data can then be correlated to the 3D data to project a plane for the top surface of the PV module. Once a 3D plane is determined for the PV module, the EOAT 240 can be positioned with the robotic manipulator 230 using this information to pick up the PV module. The perception system, operating within control system 216 and/or 232, can use algorithms to detect the edges, corners, and other uniquely identifiably features of the PV module racking system to define the 3D representation of the targeted mounting structure of the racking system (i.e., where the module is to be placed). This allows determination of the 3D position and orientation of the structure with respect to the sensor, the robotic system, and also the grasped PV modules. This information informs the manipulator, such as robotic manipulator 230, how to pose in order to place the panel correctly with respect to the racking system orientation.

FIGS. 3A-3C are perspective views illustrating a robotic PV module installation system 200 setting up a solar power generation plant. In this example, the PV module installation system 200 can include components such as an AWP 210, a linear slide 220, a robotic arm 230, and an EOM′ 240. In this example, the AWP 210 can include an articulating boom 212 and a parallel lift mechanism 214. The AWP 210 can be powered by various sources including gasoline, propane, diesel, or batteries. In this example, the linear slide 220 can include a mounting plate 222 for coupling to the AWP 210 and a slide 224. The slide 224 carries the payload of the linear slide 220, such as the robotic arm 230 in this example.

In some examples, the linear slide 220 is an EGC-HD-160-2400-TB-OH-GK with recirculating ball bearing guide from Festo Corporation of Islandia, N.Y. The example Festo linear slide includes a heavy-duty guide, a stroke length of 2400 mm, and a toothed belt. The linear slide 220 can also include a gearbox and servo motor to control operation. The example Festo linear slide can use gear box EMGA-80-P-G5-EAS-80 and servo motor EMTT-AS-80-S-LS-RM13 with servo drive CMMT-AS-C2-3A-EC-S1. In this example, the linear slide 220 is used to augment the reach of the robotic arm 230. For example, the RE2 Sapien 6M robotic manipulator has a maximum horizontal reach of 1282 mm, which can be extended 2000 mm (or more) with the linear slide 220.

FIG. 3A illustrates the PV installation system 200 retrieving PV module 120A from a stack of PV modules 150 delivered by ADV 130A. The EOAT 240 is using a series of vacuum cups to grab the PV module 120A. In this example, the robotic arm 230 has been positioned over the ADV 130A by the AWP 210. The AWP 210 roughly positions the linear slide 220 and robotic arm 230 using a combination of macro movements of the entire device coupled with positioning of the articulated arm 212 and parallel lift mechanism 214. Depending on the racking system configuration, the AWP 210 will either remain in a fixed position while the linear slide 220 and robotic arm 230 components install the PV module 120A, or the AWP 210 can manipulate the articulated arm 212 and/or parallel lift mechanism 214 in coordination with movements of the linear slide 220 and robotic arm 230. For example, in situations where the racking system is designed to hold multiple rows of PV modules, the AWP 210 may need to manipulate the articulated arm 212 and/or parallel lift mechanism 214 to provide additional vertical and/or horizontal reach for the system.

FIG. 3B illustrates the PV installation system 200 lifting the PV module 120A off of the ADV 130A. This figures also illustrates horizontal movement of the linear slide 220 in conjunction with articulation of certain joints of the robotic arm 230 to vertically lift the PV module 120A. The figure illustrates the important role of the linear slide 220 in providing additional horizontal reach to allow for sufficient movement of large PV modules without requiring the ADV 130A or the AWP 210 to risk interfering with the racking system.

FIG. 3C illustrates the PV installation system 200 performing the final positioning of the PV module 120A over the racking system 160A. In this illustration, the linear slide 220 has traversed the entire length of the slide and the robotic arm 230 is actuating additional joints to angle the PV module 120A correctly for installation on racking system 160A. From the position shown in FIG. 3C, the robotic arm 230 will extend various joints to position PV module 120A next to PV module 12013 on the racking system 160A, at which time a technician can manually secure the PV module 120A to the racking system 160A. In an alternative example, the AWP 210 (or a separate vehicle) can include an additional robotic manipulator configured to secure the PV module, while it is held in place by robotic arm 230.

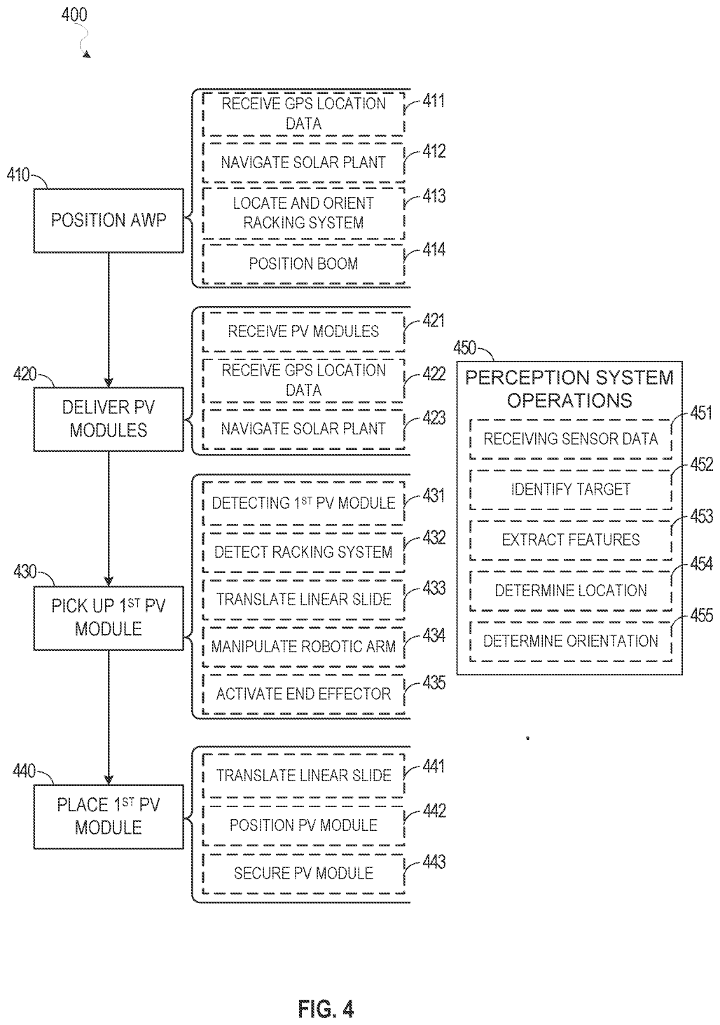

FIG. 4 is a flowchart illustrating a technique 400 of populating a solar generation plant with PV modules, according to various embodiments. In this example, the technique 400 can include operations performed by a PV module installation system such as positioning an AWP at 410, delivering PV modules at 420, picking up a PV module at 430, and placing the PV module at 440. The system can include a perception system performing related and/or supporting operations 450, the operations can include receiving sensor data at 451, identifying a target object at 452, extracting features of a target object at 453, determining a location at 454, and determining an orientation at 455. In some examples, the target object can include a PV module, a racking system, and an installation location on the racking system.

In this example, the technique 400 can begin at 410 with the AWP 210 moving into position adjacent one or more racking systems. As illustrated in FIG. 1, the AWP 110 can position itself between multiple rows of PV module racks. As noted above, the AWP in combination with the linear slide and robotic manipulator can populate PV modules on multiple adjacent racking systems. The technique 400 can include various optional additional operations associated with operation 410. For example, operation 410 can include the AWP receiving GPS location data at 411 to assist in navigating into position. The GPS data can include position data that can then be compared against waypoints or other navigation aids. At 412, the technique 400 can include the AWP 110, 210 navigating the solar generation plant. At 413, the AWP 110, 210 can utilize sensors 260 to locate and orient one or more racking systems. Finally, positioning the AWP at 410 can include positioning the articulating boom 212 at 414. In some examples, the AWP positioning adjacent a racking system at 410 can involve a perception system software operating on a controller, such as control system 216) performing some or all of the operations 450. For example, the AWP will receive sensor data at 451, such as GPS data to assist in navigation. The AWP can identity a target option at 452, such as identifying an open position on a PV racking system, or identifying the ADV loaded with PV modules for mounting. The AWP can extract features of a structure at 453, such as the structure of a mounting position on a racking system. The AWP may also perform operations 454 and 455 to determine location and orientation of an object involved in the positioning of the AWP.

At 420, the technique 400 can continue with the ADV delivering PV modules for installation on racking systems 160. Note, while operation 420 is illustrated and discussed as occurring after operation 410, the order of operations is not critical, and the PV modules could be delivered in advance of the AWP positioning for installation of the PV modules. Delivering PV modules at 420 can include an ADV, such as ADV 130A, receiving a pallet or multiple pallets of PV modules from a delivery truck or location at operation 421. Delivering PV modules at 420 can also include the ADV navigating the solar generation plant at 423, which can include receiving UPS location data at 422. In some examples, the ADV delivering PV modules at 420 can involve a perception system (e.g., software operating on a controller) performing some or all of the operations 450.

At 430, the technique 400 continues with the robotic manipulator 230 picking up a PV module from the ADV. In certain examples, picking up the PV module at 430 can include additional optional operations such as detecting a PV module at 431, detecting the racking system at 432, translating the linear slide at 433, manipulating the robotic arm at 434, and activating the end effector (EOM) at 435. Detecting the PV module at 431 can involve perception system operations 450 such as receiving sensor data at 451, identifying a target object (e.g., the PV module) at 452, extracting features of the PV module at 453, determining a location of the PV module at 454, and determining an orientation of the PV module at 455. As discussed above, these perception system operations 450 involve analyzing 2D and 3D data received from various sensors and cameras.

At 440, the technique 400 can conclude with the robotic manipulator 230 placing the PV module in a mounting position on the racking system. Placing the PV module can include optional operations such as translating the linear slide at 441, positioning the PV module at 442, and securing the PV module on the racking system at 443. Translating the linear slide, such as linear slide 220, at 441 moves the robotic manipulator 230 to provide additional reach, which allows the system to populate multiple rows of PV module racking, place the PV module in a portrait or landscape orientation, or populate more than one PV module racking system without moving the AWP 210. Positioning the PV module at 442 can include perform some of the perception system operations 450. For example, positioning the PV module can include receiving sensor data (451), identifying a target object (452) such as a mounting location, extracting features (453) of the mounting location to determine a precise location to place the PV module, and determining a location (454) and orientation (455) of the mounting location and/or racking system components. Finally, the robotic manipulator 230 can utilize a specialized EOAT 240 to both position the PV module and secure the PV module (443) to the mounting location on the racking system. Alternatively, a separate robotic arm or operator can perform the operation 443 to secure the PV module in the mounting location.

Operations discussed in reference to technique 400 can be repeated as need to populate the entire solar generation plant with PV modules. As mentioned above, the operations were discussed in a particular order, but the order of operations is not critical and operations can be performed in any logical order, such as the ADV can deliver PV modules before or after positioning the AWP.

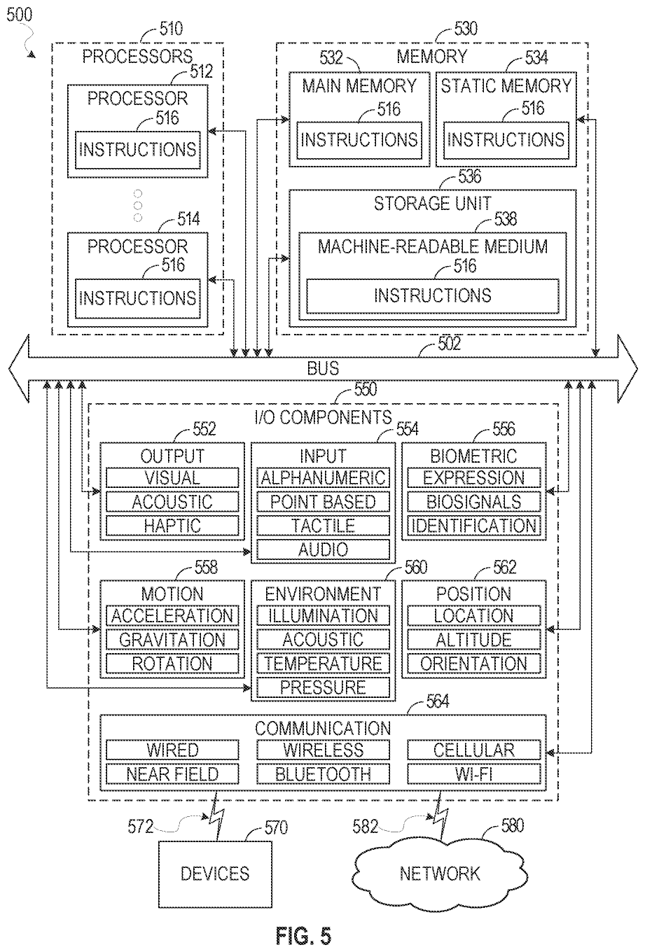

FIG. 5 is a block diagram illustrating components of a machine 500 (e.g., computing device), according to some example embodiments, able to read instructions from a machine-readable medium (e.g., a machine-readable storage medium) and perform any one or more of the methodologies (techniques) discussed herein. The machine 500 is also an exemplary computing platform that could be used to implement any of the various control systems discussed herein, such as control system 216, 232, or 250. In other examples, some of the discussed control systems can be implemented using custom circuits that are design to perform the specific functions necessary for the particular control system. Specifically, FIG. 5 shows a diagrammatic representation of the machine 500 in the example form of a computer system, within which instructions 516 (e.g., software, a program, an application, an applet, an app, or other executable code) for causing the machine 500 to perform any one or more of the methodologies discussed herein may be executed. For example, the instructions may cause the machine to execute the flow diagrams of FIG. 4. Additionally, or alternatively, the instructions implement aspects of the system 200 including the control systems 216, 232 as well as aspects of the system controller 250. The instructions also implement functionality attributed to, or discussed as operating on, AWP 110 and ADV 130. The instructions transform the general, non-programmed machine into a particular machine programmed to carry out the described and illustrated functions in the manner described. In alternative embodiments, the machine 500 operates as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a personal computer (PC), a tablet computer, a laptop computer, a netbook, a set-top box (SIB), a personal digital assistant (PDA), an entertainment media system, a cellular telephone, a smartphone, a mobile device, a wearable device (e.g., a smart watch), a smart home device (e.g., a smart appliance), other smart devices, a web appliance, a network router, a network switch, a network bridge, or any machine capable of executing the instructions 516, sequentially or otherwise, that specify actions to be taken by machine 500. Further, while only a single machine 500 is illustrated, the term “machine” shall also be taken to include a collection of machines 500 that individually or jointly execute the instructions 516 to perform any one or more of the methodologies discussed herein.

The machine 500 may include processors 510, memory 530, and I/O components 550, which may be configured to communicate with each other such as via a bus 502. In an example embodiment, the processors 510 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 512 and processor 514 that may execute instructions 516. The term “processor” is intended to include multi-core processor that may comprise two or more independent processors (sometimes referred to as “cores”) that may execute instructions contemporaneously. Although FIG. 5 shows multiple processors, the machine 500 may include a single processor with a single core, a single processor with multiple cores (e.g., a multi-core process), multiple processors with a single core, multiple processors with multiples cores, or any combination thereof.

The memory/storage 530 may include a memory 532, such as a main memory, or other memory storage, and a storage unit 536, both accessible to the processors 510 such as via the bus 502. The storage unit 536 and memory 532 store the instructions 516 embodying any one or more of the methodologies or functions described herein. The instructions 516 may also reside, completely or partially, within the memory 532, within the storage unit 536, within at least one of the processors 510 (e.g., within the processor's cache memory), or any suitable combination thereof, during execution thereof by the machine 500. Accordingly, the memory 532, the static memory 534, the storage unit 536, and the memory of processors 510 are examples of machine-readable media—such as machine-readable medium 538.

As used herein, “machine-readable medium” means a device able to store instructions and data temporarily or permanently and includes, but is not limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 516. The term “machine-readable medium” shall also be taken to include any medium, or combination of multiple media, that is capable of storing instructions (e.g., instructions 516) for execution by a machine (e.g., machine 500), such that the instructions, when executed by one or more processors of the machine 500 (e.g., processors 510), cause the machine 500 to perform any one or more of the methodologies described herein. Accordingly, a “machine-readable medium” refers to a single storage apparatus or device, as well as “cloud-based” storage systems or storage networks that include multiple storage apparatus or devices. For the purposes of this disclosure, the term “machine-readable medium” excludes signals per se.

The I/O components 550 may include a wide variety of components to receive input, provide output, produce output, transmit information, exchange information, capture measurements, and so on. The specific I/O components 550 that are included in a particular machine will depend on the type of machine. For example, portable machines such as mobile phones will likely include a touch input device or other such input mechanisms, while a headless server machine will likely not include such a touch input device. It will be appreciated that the components 550 may include many other components that are not shown in FIG. 5. The I/O components 550 are grouped according to functionality merely for simplifying the following discussion and the grouping is in no way limiting. In various example embodiments, the I/O components 550 may include output components 552 and input components 554. The output components 552 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 554 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 550 may include biometric components 556, motion components 558, environmental components 560, or position components 562 among a wide array of other components. In certain examples, the I/O components include sensors 260 discussed above. In an example, the biometric components 556 may include components to detect expressions (e.g., hand expressions, facial expressions, vocal expressions, body gestures, or eye tracking), measure bio signals (e.g., blood pressure, heart rate, body temperature, perspiration, or brain waves), identify a person (e.g., voice identification, retinal identification, facial identification, fingerprint identification, or electroencephalogram based identification), and the like. The motion components 558 may include acceleration sensor components (e.g., accelerometer), gravitation sensor components, rotation sensor components (e.g., gyroscope), and so forth. The environmental components 560 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 562 may include location sensor components (e.g., a Global Position System ((IPS) receiver component), altitude sensor components (e.g., altimeters or barometers that detect air pressure from which altitude may be derived), orientation sensor components (e.g., magnetometers), and the like. All of the different I/O components 550 discussed herein can be integrated into system 100 or 200 discussed above and the data output from these various I/O components can be used within the control systems 216, 232 or the system controller 250.

Communication may be implemented using a wide variety of technologies. The I/O components 550 may include communication components 564 operable to couple the machine 500 to a network 580 or devices 570 via coupling 582 and coupling 572 respectively. For example, the communication components 564 may include a network interface component or other suitable device to interface with the network 580. In further examples, communication components 564 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 570 may be another machine or any of a wide variety of peripheral devices (e.g., a peripheral device coupled via a. Universal Serial Bus (USB)).

Moreover, the communication components 564 may detect identifiers or include components operable to detect identifiers. For example, the communication components 564 may include Radio Frequency Identification (MD) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 564, such as, location via Internet Protocol (IP) geo-location, location via Wi-Fi™ signal triangulation, location via detecting an NEC beacon signal that may indicate a particular location, and so forth.

Transmission Medium

In various example embodiments, one or more portions of the network 580 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi™ network, another type of network, or a combination of two or more such networks. For example, the network 580 or a portion of the network 580 may include a wireless or cellular network and the coupling 582 may be a Code Division Multiple Access (CDMA) connection, a Global System for Mobile communications (GSM) connection, or other type of cellular or wireless coupling. In this example, the coupling 582 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, fifth generation wireless (5G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 516 may be transmitted or received over the network 580 using a transmission medium via a network interface device (e.g., a network interface component included in the communication components 564) and utilizing any one of a number of well-known transfer protocols (e.g., hypertext transfer protocol (HTTP)). Similarly, the instructions 516 may be transmitted or received using a transmission medium via the coupling 572 (e.g., a peer-to-peer coupling) to devices 570. The term “transmission medium” shall be taken to include any intangible medium that is capable of storing, encoding, or carrying instructions 516 for execution by the machine 500, and includes digital or analog communications signals or other intangible medium to facilitate communication of such software.

Additional Notes

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The disclosure, therefore, is not to be taken in a limiting sense, and the scope of various embodiments includes the full range of equivalents to which the disclosed subject matter is entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Each of these non-limiting examples can stand on its own, or can be combined in various permutations or combinations with one or more of the other examples.

Example 1 is a PV module installation system configured to populate a solar generation plant with PV modules. The PV module installation system can include an autonomous working vehicle (AWV) and a plurality of autonomous delivery vehicles (ADVs). The autonomous working vehicle (AWV) can be configured to install PV modules onto a racking system. The plurality of autonomous delivery vehicles (ADV) can deliver PV modules and electrical power to the AWV.

In example 2, the subject matter of example 1 includes, wherein each ADV of the plurality of ADVs docks with the AWV while the AWV installs the panels delivered by each ADV.

In example 3, the subject matter of examples 1 and 2 includes, wherein upon docking with the AWV each ADV of the plurality of ADVs transfers electrical power to the AWV to recharge batteries operating the AWV.

In example 4, the subject matter of any one of examples 1-3 includes, wherein the AWV includes a robotic arm to manipulate the PV modules.

In example 5, the subject matter of any one of examples 1-4 includes, wherein the AWV includes a secondary robotic arm including end of arm tooling to secure a PV module to the racking system.

In example 6, the subject matter of any one of examples 1-5 includes, wherein the end of arm tooling includes a device used to secure a PV module to the racking system. In some examples, the device is a torquing device.

In example 7, the subject matter of any one of examples 1-6 includes, wherein each ADV of the plurality of ADVs includes an on-board battery bank dedicated to providing electrical power to the AWV for PV module installation while each ADV is docked with the AWV.

Example 8 is a PV module installation system including an aerial work platform (AWP), a linear slide, and a robotic arm. The MVP can include an articulated boom, and the AWP can be configured for movement over off-road terrain. The linear slide can be coupled to a free-end of the articulated boom. The robotic arm can be coupled to a slide of the linear slide to increase a horizontal reach of the robotic arm through movement of the slide along the linear slide, the robotic arm can include an end of arm tooling configured to pick up PV modules.

In example 9, the subject matter of example 8 includes, wherein the AWP has four wheels independently coupled to a body of the AWP.

In example 10, the subject matter of any one of examples 8 or 9 includes, wherein the AWP has a control system configured to autonomously operate the AWP within PV module racking systems of a solar power generation plant.

In example 11, the subject matter of any one of examples 8-10 includes, wherein the control system can receive inputs from a series of sensors to assist in the autonomous operation of the AWP.

In example 12, the subject matter of any one of examples 8-11 includes, wherein the series of sensors include at least a positioning sensor and a camera.

In example 13, the subject matter of any one of examples 8-12 includes, wherein the AWP can have a parallel lift, mechanism affixed to the free-end of the articulated boom, and wherein the linear slide is coupled to a free-end of the parallel lift mechanism.

In example 14, the subject matter of any one of examples 8-13 includes, wherein the robotic arm is a 6 degree-of-freedom manipulator.

In example 15, the subject matter of any one of examples 8-14 includes, wherein the robotic arm can have a perception system for identifying PV modules and installation location on a PV module racking system. [0091.] In example 16, the subject matter of any one of examples 8-15 includes, wherein the perception system can have a two-dimensional (2D) sensor that provides data in two orthogonal dimensions and a three-dimensional sensor that provides data in three orthogonal dimensions.

In example 17, the subject matter of any one of examples 8-16 includes a 2D sensor that is a high resolution 2D optical camera.

In example 18, the subject matter of any one of examples 8-17 includes a 2D optical camera that provides 2D images in at least 8-bit color.

In example 19, the subject matter of any one of examples 8-16 includes a 3D sensor that has a pair of cameras configured for binocular determination of depth.

In example 20, the subject matter of any one of examples 8-19 includes a 3D sensor that uses cameras incorporating time-of-flight sensors to produce depth data.

In example 21, the subject matter of any one of examples 8-20 includes a perception system that has a processor and a memory device including instructions that, when executed by the processor, cause the perception system to perform operations including: identifying a. PV module; and identifying an installation location.

In example 22, the subject matter of any one of examples 8-21 includes identifying the PV module by detecting corners of the PV module within a 2D image or a 3D image.

In example 23, the subject matter of any one of examples 8-22 includes identifying the PV module by detecting edges of the PV module within a 2D image or a 3D image.

In example 24, the subject matter of any one of examples 8-23 includes identifying the installation location by detecting a position and orientation of a structural feature of a PV module racking system.

Example 25 is a method or technique for populating a solar power generation plant including operations such as positioning an aerial work platform (AWP), delivering a plurality of PV modules, picking up a PV module, and placing the PV module. In this example, the AWP can include an articulated boom, and positioning the AWP involves moving it adjacent to a racking system configured to hold PV modules. The plurality of PV modules are delivered to the AWP. Picking up the PV module from the plurality of PV modules involves using an end effector attached to a robotic arm coupled to a free-end of the articulated boom. Placing the PV module in position on the racking system is done using the robotic arm. The techniques discussed in examples 25 through 46 can be performed by the systems discussed in examples 1-24.

In example 26, the subject matter of example 25 includes positioning the AWP using a global positioning sensor within the AWP to determine a location of the AWP.

In example 27, the subject matter of any one of examples 25 and 26 includes positioning the AWP by determining a location or orientation of at least a portion of the racking system.

In example 28, the subject matter of any one of examples 25-27 includes delivering the plurality of PV modules by operating an autonomous delivery vehicle (ADV) to deliver the plurality of PV modules from a delivery location.

In example 29, the subject matter of any one of examples 25-28 includes using a sensor on the ADV to navigate between the delivery location and a location adjacent the AWP.

In example 30, the subject matter of any one of examples 25-29 includes operating the ADV by using a global positioning sensor (GPS) to navigate the ADV based on a map of the solar power generation plant and a known location of the AWP.

In example 31, the subject matter of any one of examples 25-30 includes operating the articulated boom to position the robotic arm over the plurality of PV modules delivered to the MVP by the ADV.

In example 32, the subject matter of any one of examples 25-31 includes operating the articulated boom by actuating a parallel lift mechanism affixed on the free-end of the articulated boom to vertically maneuver the robotic arm.

In example 33, the subject matter of any one of examples 25-32 includes picking up the first PV module by detecting, using a perception system, the first PV module.

In example 34, the subject matter of any one of examples 25-33 includes detecting the first PV module by determining edges of the first PV module.

In example 35, the subject matter of any one of examples 25-34 includes detecting the first PV module by determining corners of the first PV module.

In example 36, the subject matter of any one of examples 25-35 includes detecting the first PV module by determining a position and orientation of the first PV module.

In example 37, the subject matter of any one of examples 25-36 includes using the perception system to receive information from sensors including a two-dimensional (2D) sensor that provides data in two orthogonal dimensions and a three-dimensional sensor that provides data in three orthogonal dimensions.

In example 38, the subject matter of any one of examples 25-37 includes picking up the first PV module by detecting, using the perception system, at least a portion of the racking system.

In example 39, the subject matter of any one of examples 25-38 includes detecting the portion of the racking system by determining a position and orientation of the portion of the racking system.

In example 40, the subject matter of any one of examples 25-39 includes picking up the first PV module by translating the robotic arm horizontally using a linear slide coupled to the free-end of the articulated boom.

In example 41, the subject matter of any one of examples 25-40 includes placing the first PV module by translating the robotic arm horizontally using the linear slide.

In example 42, the subject matter of any one of examples 25-41 includes placing the first PV module by actuating multiple joints within the robotic arm to manipulate a position and orientation of the first PV module into a mounting position on the racking system.

In example 43, the subject matter of any one of examples 25-42 includes placing the first PV module by securing the first PV module to the racking system in the position.

In example 44, the subject matter of any one of examples 25-43 includes picking up the first PV module by attaching the end effector to a portion of the PV module.

In example 45, the subject matter of any one of examples 25-44 includes attaching the end effector to the portion of the PV module by adhering vacuum cups to a superior surface of the PV module.

In example 46, the subject matter of any one of examples 25-45 includes picking up a second PV module from the plurality of PV modules using the end effector; and placing the second PV module in a mounting position on a second racking system using the robotic arm.

In example 47, the subject matter of example 46 includes actuating a linear slide mechanism to extend a reach of the robotic arm enabling the robotic arm to reach the mounting position on the second racking system.

The above detailed description includes references to the accompanying or incorporated drawings, which form a part of the detailed description. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A PV module installation system comprising:
an aerial work platform (AWP) including an articulated boom, the AWP configured for movement over off-road terrain;
a linear slide coupled to a free-end of the articulated boom; and
a robotic arm coupled to a slide of the linear slide to increase a horizontal reach of the robotic arm through movement of the slide along the linear slide, the robotic arm including an end of arm tooling configured to pick up PV modules.

2. The PV module installation system of claim 1, wherein the AWP includes a control system configured to autonomously operate the AWP within PV module racking systems of a solar power generation plant.

3. The PV module installation system of claim 1, wherein the AWP includes a parallel lift mechanism affixed to the free-end of the articulated boom, and wherein the linear slide is coupled to a free-end of the parallel lift mechanism.

4. The PV module installation system of claim 1, wherein the robotic arm includes a perception system for identifying PV modules and installation location on a PV module racking system.

5. The PV module installation system of claim 4, wherein the perception system includes a two-dimensional (2D) sensor that provides data in two orthogonal dimensions and a three-dimensional (3D) sensor that provides data in three orthogonal dimensions.

6. The PV module installation system of claim 5, wherein the 3D sensor includes a pair of cameras configured for binocular determination of depth.

7. The PV module installation system of claim 5, wherein the 3D sensor uses cameras incorporating time-of-flight sensors to produce depth data.

8. The PV module installation system of claim 4, wherein the perception system includes a processor and a memory device including instructions that, when executed by the processor, cause the perception system to perform operations including:
identifying a PV module; and
identifying an installation location.

9. The PV module installation system of claim 8, wherein identifying the PV module includes detecting corners or edges of the PV module within a 2D image or a 3D image.

10. The PV module installation system of claim 8, wherein identifying the installation location includes detecting a position and orientation of a structural feature of a PV module racking system.

11. A method of populating a solar power generation plant, the method comprising:
positioning an aerial work platform (AWP) including an articulated boom adjacent to a racking system configured to hold PV modules;
delivering a plurality of PV modules to the AWP;
picking up a first PV module from the plurality of PV modules using an end effector attached to a robotic arm coupled to a free-end of the articulated boom; and
placing the first PV module in position on the racking system using the robotic arm.

12. The method of claim 11, wherein positioning the AWP includes determining a location or orientation of at least a portion of the racking system.

13. The method of claim 11, wherein delivering the plurality of PV modules includes operating an autonomous delivery vehicle (ADV) to deliver the plurality of PV modules from a delivery location.

14. The method of claim 13, wherein operating the ADV includes using a global positioning sensor (GPS) to navigate the ADV based on a map of the solar power generation plant and a known location of the AWP.

15. The method of claim 13, wherein positioning the AWP includes operating the articulated boom to position the robotic arm over the plurality of PV modules delivered to the AWP by the ADV.

16. The method of claim 11, wherein picking up the first PV module includes detecting, using a perception system, the first PV module.

17. The method of claim 16, wherein detecting the first PV module includes determining a position and orientation of the first PV module.

18. The method of claim 17, wherein using the perception system includes receiving information from sensors including a two-dimensional (2D) sensor that provides data in two orthogonal dimensions and a three-dimensional sensor that provides data in three orthogonal dimensions.

19. The method of claim 11, wherein picking up the first PV module includes detecting, using a perception system, at least a portion of the racking system including determining a position and orientation of the portion of the racking system.

20. The method of claim 11, wherein picking up the first PV module includes translating the robotic arm horizontally using a linear slide coupled to the free-end of the articulated boom.

21. A method of populating a solar power generation plant, the method comprising:
positioning an aerial work platform (AWP) including an articulated boom adjacent to a racking system configured to hold PV modules;
delivering a plurality of PV modules to the AWP;
picking up a first PV module from the plurality of PV modules using an end effector attached to a robotic arm coupled to a free-end of the articulated boom;
placing the first PV module in position on the racking system using the robotic arm;
picking up a second PV module from the plurality of PV modules using the end effector; and
placing the second PV module in a mounting position on a second racking system using the robotic arm.

22. The method of claim 21, further comprising actuating a linear slide mechanism to extend a reach of the robotic arm enabling the robotic arm to reach the mounting position on the second racking system.

23. The method of claim 21, wherein delivering the plurality of PV modules to the AWP includes transferring electrical power to the AWP from a delivery vehicle.
